(19) United States
(12) Patent Application Publication
(10) Pub. No.: US 2025/0269998 A1
(43) Pub. Date: Aug. 28, 2025

(54) Protective Device for a Machine

(71) Applicant: Krones AG, Neutraubling (DE)

(72) Inventors: Antonia NIEMANN, Pfatter (DE); Reimund HOF, Nittenau (DE); Joerg KRAUSE, Regensburg (DE); Michael MAUL, Volkenschwand (DE)

(21) Appl. No.: 19/064,562

(22) Filed: Feb. 26, 2025

(30) Foreign Application Priority Data
Feb. 27, 2024 (DE) 10 2024 105 495.6

(51) Int. Cl. B65C 9/40; F16P 3/02

(52) U.S. Cl. CPC B65C 9/40; F16P 3/02

(57) ABSTRACT

A protective device for a machine, for example a container treatment machine, includes a protective element movable in the vertical direction and a pneumatic unit connected to the protective element. The pneumatic unit comprises a pressurizable pneumatic element, which is configured to substantially compensate for the weight force of the protective element during a movement along the vertical direction.

### CROSS-REFERENCE TO RELATED APPLICATIONS

This application claims priority to, and the benefit of, German Patent Application No. 10 2024 105 495.6, filed Feb. 27, 2024, the contents of which are incorporated by reference in their entirety.

### TECHNICAL FIELD

The present invention relates to a protective device for a machine, for example a container treatment machine, and to a container treatment machine for treating containers.

### BACKGROUND

Protective devices for machines are known from the prior art. They are typically used to shield a region of the machine from operator intervention. In this way, moving components of the machine, which could pose a significant risk of injury in case of operator intervention, can, for example, be protected from operator intervention. This increases operational safety.

Such a protective device is disclosed, for example, in WO 2010/099822 A1. Here, at least one protective element is moved along a predetermined movement path via suitable guide means, which are connected to the base frame of the container treatment machine. Additional aids to facilitate the movement of the protective element are also provided.

However, depending on the size of the protective element to be moved (in particular its weight), it is difficult for an operator to move the protective element, for example, between the closed position (also referred to as the protective position) and an open position, in which, for example, a moving component of the machine may be accessible to an operator from the outside. This usually entails an undesirable risk of injury or negatively affects the operability of the protective device.

### BRIEF SUMMARY

Starting from the known prior art, the technical object to be achieved is therefore to specify a protective device for a machine, in particular a container treatment machine, which can be operated by an operator regardless of their physical constitution and which at the same time ensures operational safety.

The object is achieved according to the invention by a protective device for a machine, for example a container treatment machine, according to claim 1 and by the container treatment machine for treating containers according to claim 10. Advantageous developments of the invention are disclosed in the dependent claims.

The protective device according to the invention for a machine, for example a container treatment machine, comprises a protective element movable in the vertical direction and a pneumatic unit connected to the protective element, wherein the pneumatic unit comprises a pressurizable pneumatic element, which is configured to substantially compensate for the weight force of the protective element during a movement along the vertical direction.

To this effect, the pressurizable pneumatic element is connected to the protective element such that the weight force acting on the protective element is balanced or compensated by the pressure prevailing in the pneumatic element. For example, when the protective element is not moving, the pressure in the pneumatic element thus counteracts the weight force of the protective element so that the protective element remains in its position. If the protective element is moved along the direction of gravity (i.e., downwards), the pressure in the pneumatic element increases and is reduced to compensate for the weight force in order to avoid building up pressure that counteracts the movement of the protective element and goes beyond compensating for the weight force. If the protective element is moved upwards (against the direction of gravity), the pressure in the pneumatic element decreases and, in order to compensate for the weight force, the pressure in the pneumatic element is increased.

The “substantial” compensation of the weight force of the protective element means that the pneumatic element is always subjected to such a pressure that, preferably, the pressure prevailing in the pneumatic element exactly balances or compensates for the weight force of the protective element. However, the term “substantially compensating for the weight force” may also include the fact that the weight force is compensated by at least 85%, preferably at least 90%, particularly preferably at least 95%, in particular when the protective element is moving. This also includes an overcompensation of the weight force of up to 5% or up to 10% or up to 15%.

Exact compensation of the weight force of the protective element during a movement along the vertical direction makes simplest handling by an operator possible but can involve greater control-related effort since the pressure prevailing in the pneumatic element, which counteracts the weight force of the protective element during the movement, must be adjusted very precisely. If a deviation from the full compensation of the weight force of the protective element is permitted during movement, this means that an operator must apply a certain force in order to move the protective element with or against the direction of gravity. However, the control-related effort is reduced, which can reduce the complexity of the protective device.

With this protective device, protection of the operator can be ensured at all times. At the same time, moving the protective element is simplified and is, in particular, no longer dependent on the operator's physical constitution, which allows for easier handling.

It may be provided for the pneumatic unit to comprise a compressed air supply, wherein the compressed air supply is designed to apply a gas pressure to the pneumatic element which substantially compensates for the weight force of the protective element during an upward movement of the protective element. The gas can be (but does not necessarily have to be) air.

It may be provided in this case that the compressed air supply comprises an inlet valve, via which, during an upward movement of the protective element, the pressure prevailing in the pneumatic element is increased such that the weight force of the protective element is substantially compensated.

This allows for the weight force of the protective element to be reliably compensated, preferably during the entire movement of the protective element in a direction against gravity (upward movement).

In one embodiment, it is provided for the pneumatic unit to comprise a relief valve, via which excess pressure present in the pneumatic element can be released when the protective element is lowered, so that when the protective element is lowered, the weight force of the protective element is substantially compensated and/or no force counteracting the downward movement is caused by the pressure prevailing in the pneumatic element.

Since the pressure prevailing in the pneumatic element, which pressure counteracts the weight force of the protective element, increases during a downward movement, said relief valve ensures that no or at most little additional force against the direction of gravity is required from the operator even when the protective element is moved downwards, since the weight force of the protective element is substantially compensated during the entire downward movement without building up a force counteracting the downward movement.

It can be provided for the inlet valve and/or the relief valve to be or comprise a pressure control valve. This allows for the weight force to be precisely compensated throughout the entire movement.

The pneumatic unit can comprise a check valve in a supply line of the pneumatic element, wherein the check valve can be configured to keep a pressure in the pneumatic element constant in the event of a pressure drop in the supply line.

This embodiment ensures that the pneumatic element cannot inadvertently, for example due to a defect, no longer act to compensate for the weight force of the protective element, which would lead to a risk of injury to the operator in the event of a defect during movement of the protective element. This increases operational safety.

It can be provided for the pneumatic element to be connected to the protective element at a connection point, wherein the connection point is arranged in a region along a horizontal extension L of the protective element, wherein the region is arranged between 0.25 L and 0.75 L or between 0.4 L and 0.6 L.

The region between 0.25 L and 0.75 L or 0.4 L and 0.6 L is in particular arranged such that it is measured to the left or right of the horizontal extension when viewed from a boundary of the protective element. This requires a substantially central arrangement of the pneumatic element relative to the protective element. This reduces any torque that may act on the protective element/or the pneumatic element, allowing for more reliable compensation of the weight force of the protective element.

In one embodiment, it is provided for the protective element to comprise a locking element, with which the protective element can be locked in a protective position. The protective position is the position of the protective element in which the protective element can prevent an operator from reaching into a moving component of a machine.

This locking element ensures that the protective element cannot accidentally move out of the protective position. This further increases operational safety.

The protective device can comprise a stationary element and the protective element can be arranged to be movable relative to the stationary element.

The stationary element can, for example, be part of the protective device through which an operator is not supposed to reach into the region screened off by the protective device, so that this region remains permanently closed by the protective device. This can further increase operational safety.

The protective device can comprise at least one protective element, preferably at least two protective elements, wherein an independent pneumatic unit can be connected to each protective element.

This embodiment allows the movement of several protective elements independently of one another and with little effort from the operator.

According to the invention, a container treatment machine for treating containers, such as bottles, is further provided, the container treatment machine comprising at least one moving component and a protective device according to one of the preceding embodiments, wherein the protective device is arranged such that in a protective position of the protective element, the moving element is arranged within a region at least partially delimited by the protective device.

In particular, in the protective position of the protective element, an operator's intervention in the delimited region can be avoided or prevented by the protective element acting as a physical barrier through which an operator cannot reach into the delimited region from outside the protective device.

This reduces the risk of injury to an operator while ensuring ease of use.

It can be provided for the container treatment machine to comprise a treatment unit which comprises the at least one moving component, wherein, in the protective position of the protective element, the treatment unit extends at least partially through the protective device.

A treatment unit can be understood to mean in particular an apparatus that can carry out a treatment on a container. However, a treatment unit cannot exclusively be understood to mean, for example, a labeling unit that can apply labels to containers moving past it. This embodiment reduces the operator's protection from accidentally reaching into a moving component, but at the same time keeps the space requirement of the protective device to a minimum since, for example, parts of the treatment unit that do not comprise moving components can protrude from the protective device.

It can be provided for the moving component to comprise a carousel, a star wheel, a transfer cylinder or a pallet shaft. These components typically move at high speeds during operation so that there would be a significant risk of injury to an operator in the event of unintentional intervention during operation. This embodiment reliably minimizes the risk of injury.

The protective device can be firmly connected to a frame of the container treatment machine.

The frame can, for example, be a stationary part of the container treatment machine. The protective device is stabilized by connecting it to the frame, which can improve its protective effect.

### BRIEF DESCRIPTION OF THE DRAWING FIGURES

FIG. 1 shows a container treatment machine according to one embodiment; and

FIG. 2 shows a protective element together with a pneumatic unit according to one embodiment.

### DETAILED DESCRIPTION

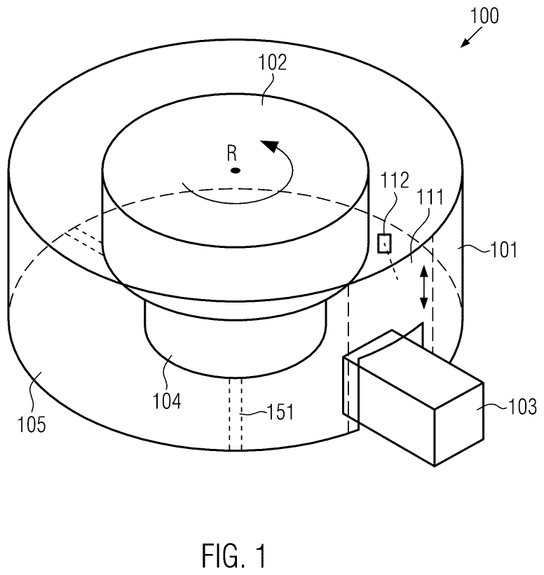

FIG. 1 shows a container treatment machine 100 according to one embodiment of the invention. The type of container treatment machine is not limited according to the invention and the container treatment machine can be or comprise a fitting machine, for example a labeling machine or a direct printing machine for fitting/decorating containers, or can be designed as a machine that can produce containers for example from preforms (such as a blow-molding machine or form filling machine). It is also conceivable for the container treatment machine 100 to be configured as an inspection device or other machine that can interact with containers in some way.

In addition, the invention is not limited to use in a container treatment machine, but can also be applied generally, for example to industrial machines.

According to the invention, a protective device 101 is provided, which can in particular be provided to protect a moving component of the container treatment machine 100 at least partially from intervention by an operator. For this purpose, the protective device 101 can, for example, completely enclose the moving component or enclose all moving components of the container treatment machine.

A moving component can herein be understood to mean, for example, a treatment carousel 102 of the container treatment machine 100. Along its periphery, the treatment carousel can, for example, comprise a series of container treatment stations and/or container receptacles (not shown), in which containers can be received and optionally treated. The treatment carousel 102 can, for example, be mounted so as to be rotatable about the rotation axis R. Alternatively or additionally, a moving component can also be provided as part of a treatment unit 103 (for example a labeling unit). The moving component can, for example, be a pallet shaft for picking up labels from a supply. This moving component can also be arranged within the protective device 101 or in a region at least partially delimited by the protective device. Alternatively or additionally, the moving components can also comprise one or more star wheels or similar devices. The components are not limited according to the invention and any component that is movable in any way and which, due to its movement, can in particular entail a risk of injury to an operator, is covered by the invention.

According to the invention, the protective device 101 comprises at least one protective element 111 arranged to be movable along a vertical direction. The protective element 111 can, for example, be made of Plexiglas or comprise Plexiglas and thus offer protection against intervention by an operator in that the protective element serves as a physical barrier.

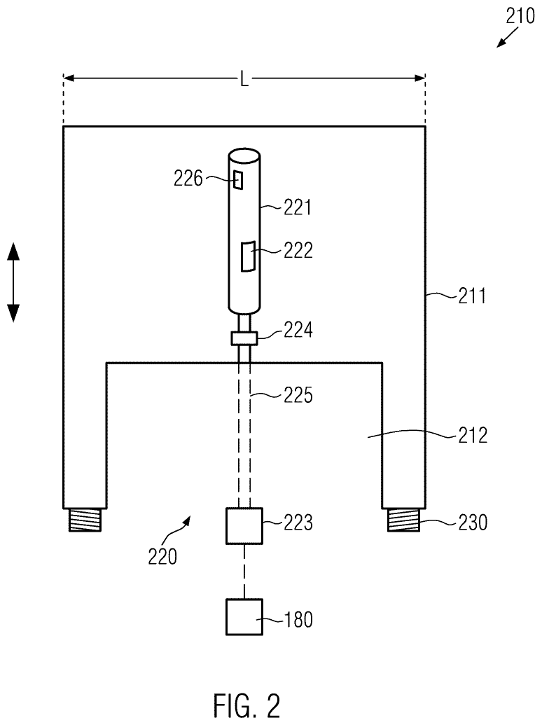

According to the invention, the protective element 111 is connected to a pneumatic unit 112. According to the invention, said pneumatic unit allows for substantially compensating for the weight force of the protective element during movement of the protective element 111 against or with the direction of gravity (i.e., at least in the vertical direction). For this purpose, the pneumatic unit 112 comprises a pressurizable pneumatic element connected to the protective element, as will be described with reference to FIG. 2.

In one embodiment, the protective device 101 can also comprise several (at least two) protective elements that are movable in the vertical direction, so that, for example, access to one or more moving components of the container treatment machine is also possible from several positions. In one embodiment, it is provided for each of these moving protective elements to be connected to a pneumatic unit assigned to said protective element, such that the pressurizable pneumatic element can substantially compensate for the weight force of the protective element during its movement along the vertical direction. The pneumatic units are preferably independent of one another so that each protective element can be moved independently of the position of the other protective elements.

The movement of the protective element in the vertical direction is preferably a movement between a protective position (which corresponds to a position of the protective element in which it can exert the intended protective effect) and an open position or release position (in which the protective element allows the operator to intervene in the moving component).

By compensating for the weight force of the protective element during its movement with the aid of the pneumatic unit or in particular the pneumatic element, it is achieved that an operator, regardless of their physical constitution, can move the protective element into the protective position and/or into the open position, thus facilitating handling or interaction with the container treatment machine. At the same time, the protective device can ensure reliable protection for the operator.

In the embodiment shown here, the protective device 101 comprises a stationary element 105 in addition to the at least one moving protective element 111, wherein the protective device 101 in the embodiment shown here substantially completely surrounds at least the treatment carousel 102. This stationary element 105 can, for example, be firmly connected to a stationary part of the container treatment machine (here, for example, a base or frame 104 of the treatment carousel) via suitable connecting elements 151 (for example, struts). Alternatively or additionally, a connection can also be made to a stationary part of the container treatment machine above the carousel or to side frames or supports of the container treatment machine. On the one hand, this ensures that the protective device cannot accidentally fall over, which could lead to damage to the container treatment machine. On the other hand, this ensures that the stationary element 105 and also the protective element 111 always (if possible) maintain the necessary distance from the moving components of the container treatment machine.

It can be provided for the moving protective element 111 to be connected to the stationary element 105 such that the protective element 111 can be moved relative to the stationary element but is connected to it, for example, via guide elements. As a result, the range of motion of the protective element 111 can be limited, for example in the horizontal direction, which ensures that there is no damage to the container treatment machine even if the operator moves the moving protective element 111. The connecting elements can, for example, be pairs of corresponding rails or sliding elements so that the protective element 111 can be moved along, for example, a guide rail of the stationary element 105.

FIG. 2 shows an embodiment of a moving protective element 210 corresponding to the moving protective element 111 of FIG. 1. This moving protective element 210 is intended to be used in combination with any of the embodiments described in connection with FIG. 1.

The moving protective element 210 shown in FIG. 2 can be embodied as a substantially continuous Plexiglas pane 211 or similar continuous element which extends over a surface in particular in the horizontal direction (in direction L) and in the vertical direction. This surface can, but does not have to, be regular and can, for example, be a rectangle or a cylinder shell section. Optionally, however, the protective element can also comprise one or more openings or indentations 212, which can, for example, be shaped such that in a protective position of the protective element 210, a moving component of the container treatment machine is completely protected from intervention by an operator. If the protective element is moved from the protective position to the open position, the operator can also access the moving component, for example through the opening 212. The opening 212 may be shaped to match the shape of a component of the container treatment machine that extends at least partially through the protective device (for example a treatment unit such as a labeling unit). This reduces the risk of unintentional intervention by an operator in the region shielded by the protective device.

In one embodiment, the protective element 210 can further comprise a locking element 230, with which the protective element can be locked in a protective position. The locking element 230 can, for example, comprise hooks or similar locking mechanisms that can be engaged with corresponding elements of the protective device and/or container treatment machine when the protective element assumes the protective position. It can be provided that moving the protective element 210 out of the protective position is not possible without releasing the locking element.

In the embodiment shown in FIG. 2, the pneumatic unit 220 comprises a pneumatic element 221 which is configured as a pressurizable pneumatic cylinder. For this purpose, one side of the pneumatic cylinder 221 can be connected to a compressed air supply 223, for example via a compressed air line (supply line) 225, so that the pneumatic cylinder can be supplied with compressed air from one side.

Optionally, it may be provided that the compressed air supply 223 comprises an inlet valve, via which, during an upward movement of the protective element 210, the pressure prevailing in the pneumatic element 221 is increased such that the weight force of the protective element 210 is substantially compensated.

Furthermore, the pneumatic unit can optionally comprise a relief valve 226, through which an existing excess pressure in the pneumatic element, in particular in the pneumatic cylinder, can be released. The pneumatic cylinder, in particular a moving component of the pneumatic cylinder (for example the cylinder rod), is connected to the moving protective element 210 at a connection point 222 so that the moving part of the pneumatic unit can move with the moving protective element. The connection point 222 is preferably arranged such that it is located approximately centrally (in the horizontal direction) on the moving protective element. The forces acting on the pneumatic unit through the protective element are thereby compensated preferably in the horizontal direction so that no or only low torques act on the connection point 222 and/or the moving component of the pneumatic element. Preferably, the connection point 222 can be arranged in a region between 0.25 L and 0.75 L as seen from the left or right boundary of the protective element 210 shown here in FIG. 2. Particularly preferably, this region extends between 0.4 and 0.6 L as seen from one of the boundaries, wherein L is the extension of the protective element in the horizontal direction. In the vertical direction, the pneumatic unit can be connected to the protective element in any way. In particular, the pneumatic unit can also be arranged completely above or below the moving protective element 210 and may be connected to the protective element only via suitable connecting elements (for example an extension of the cylinder rod) at the connection point 222.

According to the invention, it is provided for the pneumatic unit 221 (for example the pneumatic cylinder) to be pressurizable via the compressed air supply 223 such that during an upward movement of the moving protective element 210 (i.e., against the direction of gravity) and/or during a downward movement of the moving protective element 210, the pressure acting in the pneumatic unit counteracts, in particular substantially compensates for, the weight force of the protective element.

During an upward movement, this includes the pneumatic unit 221 being supplied with compressed air (or another pressurized gas) via the compressed air supply, so that the pressure within the pneumatic unit is kept constant and the weight force of the protective element is compensated. The compressed air can, for example, be supplied through an inlet valve. If, however, the protective element is moved downwards, whereby at least part of the pneumatic unit also moves against the pressure prevailing therein, the pressure is reduced, for example, by releasing gas or air from the relief valve 226 so that it preferably substantially compensates for the weight force of the moving protective element during movement of the moving protective element.

If the pneumatic unit 221 is configured as a single-acting pneumatic cylinder, it can be provided for a separate inlet valve and/or a separate relief valve 226 to be dispensed with.

In one embodiment, the inlet valve and/or the relief valve 226 can be embodied in particular as a pressure control valve. With a pressure control valve, the pressure prevailing in the pneumatic cylinder can be adjusted particularly reliably during a downward movement of the moving protective element 210, so that the weight force of the moving protective element 210 can be compensated as completely as possible even during jerky movements.

It can be provided that the compressed air supply 223 (for example the inlet valve) and the relief valve 226 can be controlled by an operator. For example, a push button may be provided for operation by an operator, wherein, as a standard feature, the inlet valve is open and the relief valve 226 is closed so that a higher pressure is applied to the pneumatic element 221, and wherein, when the push button is operated (and held), the inlet valve is closed and the relief valve 226 is open so that a lower pressure is applied to the pneumatic element 221.

It can also be provided for a control unit 180 (for example a computer with associated memory and program instructions stored thereon for controlling one or more functions of the container treatment machine of FIG. 1) to control the compressed air supply 223 depending on a pressure prevailing in the pneumatic cylinder 221, such that it is always in contact. The control unit 180 can also control the relief valve 226 so that by controlling these two components, the weight force of the protective element 210 is compensated as much as possible at all times by the pressure prevailing in the pneumatic element. It can be provided for one or more pressure sensors to be arranged, for example, in the supply line 225 and/or in the pneumatic unit, which can measure the prevailing pressure; based on the measured pressure, the control unit can then control either the compressed air supply or the relief valve in order to increase or decrease the pressure in the pneumatic unit.

It can be provided for the compressed air supply or the relief valve to be controlled depending on the direction of movement of the protective element. If the protective element is moved upwards (i.e., against the direction of gravity), the pressure in the pneumatic unit must be increased so that it may be provided for the control unit to control only the compressed air supply when the protective element moves upwards. If the protective element is moved downwards (i.e., in the direction of gravity), it may be provided for the control unit 180 to control only the pressure reduction, for example via the relief valve. Overrides or undesirable dynamic effects when controlling the relief valve and the compressed air supply at the same time can thus be avoided.

In one embodiment, a check valve 224 can be arranged in the supply line 225, which check valve is configured to keep a pressure in the pneumatic element constant in the event of a pressure drop in the supply line 225. For this purpose, the check valve can, for example, prevent compressed air from flowing out of the pneumatic element 221 in the direction of the supply line 225 if the pressure suddenly drops upstream of the check valve 224 in the supply line or the compressed air supply. This can ensure that in the given position of the protective element 210, in the event of a pressure drop in the supply line, the weight force of the protective element 210 is substantially compensated at least in this position.

Although a downward or upward movement of the protective element can then be achieved only with a great increase of force applied by the operator, or cannot be achieved at all by the operator (if a movement against the acting pressure is even possible), the risk of injury to an operator due, for example, to the sudden full effect of the weight force of the protective element is also reduced or avoided.

While the invention has been described with respect to certain embodiments, the description is intended to be exemplary, rather than limiting. Modifications and changes may be made within the scope of the invention, which is defined by the appended claims.

What is claimed is:

1. A protective device for a machine, comprising:
at least one protective element movable in the vertical direction; and
a pneumatic unit connected to the protective element, the pneumatic unit including a pressurizable pneumatic element, which is configured to substantially compensate for the weight force of the protective element during a movement along the vertical direction.

2. The protective device according to claim 1, wherein the pneumatic unit comprises a compressed air supply, wherein the compressed air supply is designed to apply a gas pressure to the pneumatic element which substantially compensates for the weight force of the protective element during an upward movement of the protective element.

3. The protective device according to claim 2, wherein the compressed air supply comprises an inlet valve, via which, during an upward movement of the protective element, the pressure prevailing in the pneumatic element is increased such that the weight force of the protective element is substantially compensated.

4. The protective device according to claim 1, wherein the pneumatic unit comprises a relief valve via which excess pressure present in the pneumatic element can be released when the protective element is lowered, so that the weight force of the protective element is substantially compensated when the protective element is lowered.

5. The protective device according to claim 4, wherein the relief valve is or comprises a pressure control valve.

6. The protective device according to claim 1, wherein the pneumatic unit comprises a check valve in a supply line of the pneumatic element, wherein the check valve is configured to keep a pressure in the pneumatic element constant in the event of a pressure drop in the supply line.

7. The protective device according to claim 1, wherein the pneumatic element is connected to the protective element at a connection point, and wherein the connection point is arranged in a region along a horizontal extension L of the protective element, wherein the region is arranged between 0.25 L and 0.75 L or between 0.4 L and 0.6 L.

8. The protective device according to claim 1, wherein the protective element comprises a locking element, with which the protective element can be locked in a protective position.

9. The protective device according to claim 1, wherein the protective device comprises a stationary element, and wherein the protective element is arranged to be movable relative to the stationary element.

10. The protective device according to claim 1, wherein the protective device comprises at least two protective elements, and wherein an independent pneumatic unit is connected to each protective element.

11. The protective device according to claim 1, wherein the machine is a container treatment machine.

12. A container treatment machine for treating containers, the container treatment machine comprising at least one moving component and a protective device according to claim 1, wherein the protective device is arranged such that in a protective position of the protective element, the moving element is arranged within a region at least partially delimited by the protective device.

13. The container treatment machine according to claim 12, wherein the container treatment machine comprises a treatment unit which comprises the at least one moving component, and wherein, in the protective position of the protective element, the treatment unit extends at least partially through the protective device.

14. The container treatment machine according to claim 12, wherein the moving component comprises a carousel, a star wheel, transfer cylinder or a pallet shaft.

15. The container treatment machine according to claim 12, wherein the protective device is firmly connected to a frame of the container treatment machine.

16. The container treatment machine according to claim 12, wherein the containers comprise bottles.
